(19) United States
(12) Patent Application Publication
(10) Pub. No.: US 2007/0229457 A1
(43) Pub. Date: Oct. 4, 2007

(54) Electronic Blackboard System and Method of Controlling Display Thereof

(75) Inventor: Naoya Sakurai, Fukuoka (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 11/597,210

(22) PCT Filed: May 25, 2005
(86) PCT No.: PCT/JP05/10007

§ 371 Date: Nov. 21, 2006

(30) Foreign Application Priority Data
May 26, 2004 (JP) 2004-155834

(51) Int. Cl. G06F 3/033

(52) U.S. Cl. 345/157

(57) ABSTRACT

An electronic blackboard system characterized in including a position detecting portion for detecting a position of a member brought into contact with a screen, an electronic paper for displaying the position of the member detected by the position detecting portion on the screen as a locus, a control portion for controlling the position detecting portion and the electronic paper to display the locus of the member on the screen as drawing information, and a storing portion for storing the drawing information controlled to display by the control portion, in which writing can be executed on a writing face without an exclusive pen, a character or a graphic can be displayed on the screen by a simple apparatus constitution, and displayed information can be stored to an apparatus main body.

### TECHNICAL FIELD

The present invention relates to an electronic blackboard system capable of recoding characters or the like written on a screen on paper or holding the characters or the like as PC data and a method of controlling display thereof.

### BACKGROUND ART

In recent years, there is seen an electronic blackboard system mounted with a function of recording characters or the like drawn on a screen by various systems.

Here, an outline of an electronic blackboard system of a related art will be explained in reference to FIG. 16, FIG. 17, and FIG. 18. FIG. 16 is an outline view showing an electronic blackboard system of a related art, FIG. 17 is an outline view showing an example of a projecting type electronic blackboard system of a related art, and FIG. 18 is an outline view showing an example of an electronic blackboard system of a tablet type of a related art.

As shown by FIG. 16, there is an electronic blackboard system of a related art in which characters or the like drawn by a marker 132 on a screen 131 can be scanned by a mounted scanner 133 over a total of the screen by driving the scanner 133 or the screen 131 and can be printed on paper by a similarly mounted printer 134.

Further, as shown by FIG. 17, there also is an electronic blackboard system of a related art in which characters or the like drawn by a member 10 of an electronic pen, the finger, a stylus or the like on a screen 141 having a position detecting apparatus are inputted to PC 143 by way of an interface cable 142 and projected onto the screen by a projector 145 by way of an image cable 144. JP-A-2002-304252 describes an electronic blackboard disclosing a specific related art.

Further, as shown by FIG. 17, there is also an electronic blackboard system of a related art in which a position detecting apparatus is attached to a plasma TV or the like, characters or the like drawn by the member 10 of an electronic pen, the finger, a stylus or the like are inputted to PC 153 by way of an interface cable 142 and displayed on the screen by way of an image cable 154 to thereby realize the system without a projector.

However, when the characters or the like are outputted to paper, a content thereof is not formed into digital data and therefore, there poses a problem in view of effectively utilizing data. Further, since the marker is used, in order to draw a new content, a locus drawn on the screen needs to be erased by an eraser or the like. Further, since the marker and the eraser are expendables, cost is taken for buying new ones thereof. Further, a total of the screen needs to scan optically by driving the screen or the scanner and therefore, a mechanism of the screen portion becomes large-scaled.

Further, when the projector is used as shown by FIG. 18, in presentation or the like, when one stands in front of the projector, a shadow is cast thereon and the projector is difficult to use. Hence, when the plasma TV or the like is used as shown by FIG. 18, the system is expensive and heavily weighted and is inconvenient to move. Further, in FIG. 17 and FIG. 18, PC needs to be connected necessarily and therefore, settings until using PC are troublesome.

### DISCLOSURE OF THE INVENTION

The invention provides an electronic blackboard system which is an electronic blackboard system for displaying a character or a graphic on a screen, the electronic blackboard system including a position detecting apparatus and a display apparatus which are light-weighted as a screen, drawing information written on a writing face can be displayed without using an exclusive pen or a projector and data can be held and called by an apparatus per se and a method of controlling display thereof.

In an electronic blackboard system and a method of controlling display thereof of the invention, there is provided an electronic blackboard system characterized in comprising a position detecting portion for detecting a coordinates position with which a writing member is brought into contact, a display medium in which a pixel selectively produces a color by electricity conduction and a color-produced state is maintained even after cutting the electricity conduction, a control portion for executing a control to be able to directly drawn on the display medium based on position information from the position detecting portion, and a storing portion for storing drawing information drawn on the display medium.

Thereby, in the electronic blackboard system and the method of controlling display thereof of the invention, a user can display a character or a graphic traced by a member 10 of the finger or a stylus at the screen as it is on the screen without a marker or an electronic pen and can easily carry the apparatus.

Further, the electronic blackboard per se is mounted with position detecting means and displaying means which are light-weighted and therefore, when a sentence or a graphic can be drawn on the screen without connecting a projector or PC, the apparatus can easily be moved, and drawn data can be held and called by the electronic blackboard per se, a user can draw the sentence or the graphic without a marker or an electronic pen, can easily move the apparatus and can use the electronic blackboard without connecting a peripheral apparatus of a projector, PC or the like.

### BRIEF DESCRIPTION OF THE DRAWINGS

FIG. 1 is an explanatory view showing an electronic blackboard system according to an embodiment of the invention.

FIG. 2 is an explanatory view showing a position detecting apparatus and a display apparatus provided to the electronic blackboard system of FIG. 1.

FIG. 3 is a hardware block diagram of a main body provided to the electronic blackboard system of FIG. 1.

FIG. 4 is a functional block diagram showing the electronic blackboard system of FIG. 2.

FIG. 5 is a hardware block diagram showing a circuit constitution of the position detecting apparatus of FIG. 2.

FIG. 6 is an explanatory view showing a structure of document information in the functional block diagram of FIG. 4.

FIG. 7(a) is an explanatory view showing an example of data stored to drawing information of a character, and FIG. 7(b) is an explanatory view showing an example of data stored to drawing information of a rectangle.

FIG. 8(a) is an explanatory view enlarging a color palette of an electronic blackboard system, and FIG. 8(b) is an explanatory view showing an example of an edition dialog screen of color.

FIG. 9(a) is an explanatory view enlarging a tool palette of FIG. 1, and FIG. 9(b) is an explanatory view showing an example of an edition dialog screen for forming or changing a rectangle.

FIG. 10 is a flowchart showing processings in operating the position detecting apparatus and the display apparatus of FIG. 2 on a screen.

FIG. 11 is a flowchart showing processings in operating the position detecting apparatus and the display apparatus of FIG. 2 on a screen in selecting a rectangle.

FIG. 12 is a flowchart showing processings of the position detecting apparatus and the display apparatus of FIG. 2 in operating a page.

FIG. 13 is a flowchart showing processings of the position detecting apparatus and the display apparatus of FIG. 2.

FIG. 14 is a block diagram showing the display apparatus provided to the electronic blackboard system of FIG. 1.

FIG. 15 shows a disk apparatus of an ultra small type HDD as a memory or a recording apparatus according to the embodiment.

FIG. 16 is an outline view showing an example of an electronic blackboard system of a related art.

FIG. 17 is an outline view showing an example of a projecting type electronic blackboard system of a related art.

FIG. 18 is an outline view showing an example of an electronic blackboard system of a tablet type of a related art.

### BEST MODE FOR CARRYING OUT THE INVENTION

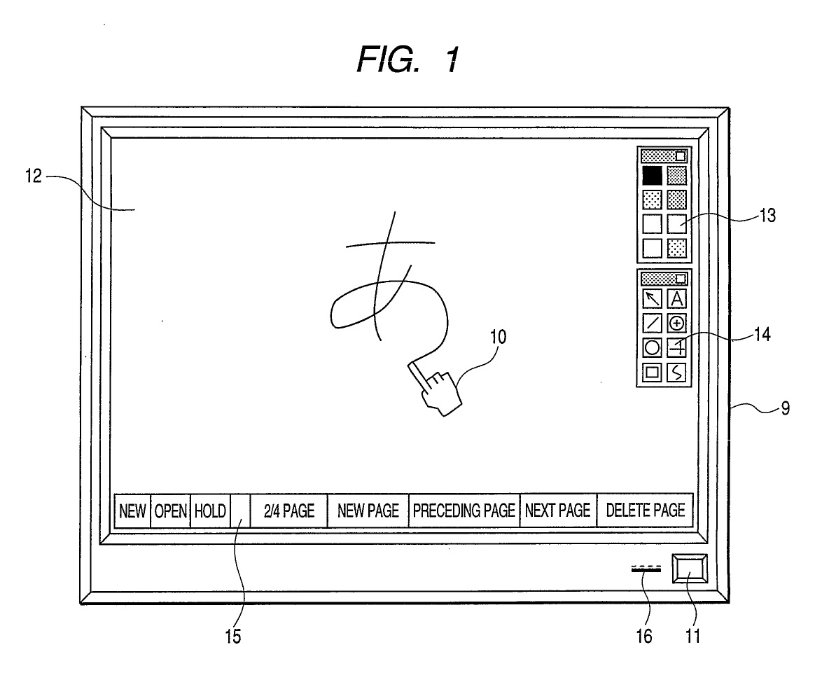

An embodiment of the invention will be explained in reference to FIG. 1 through FIG. 14 as follows.

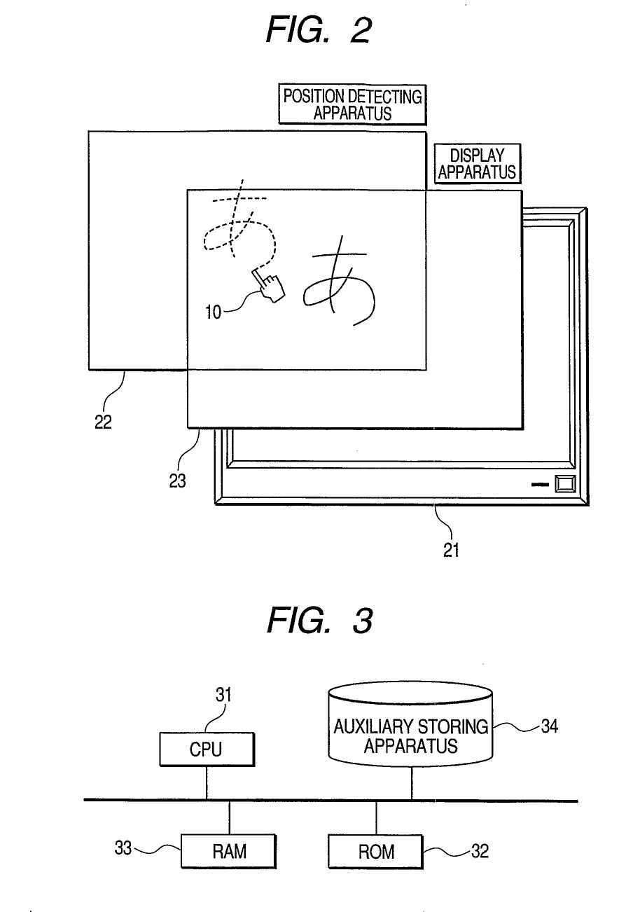

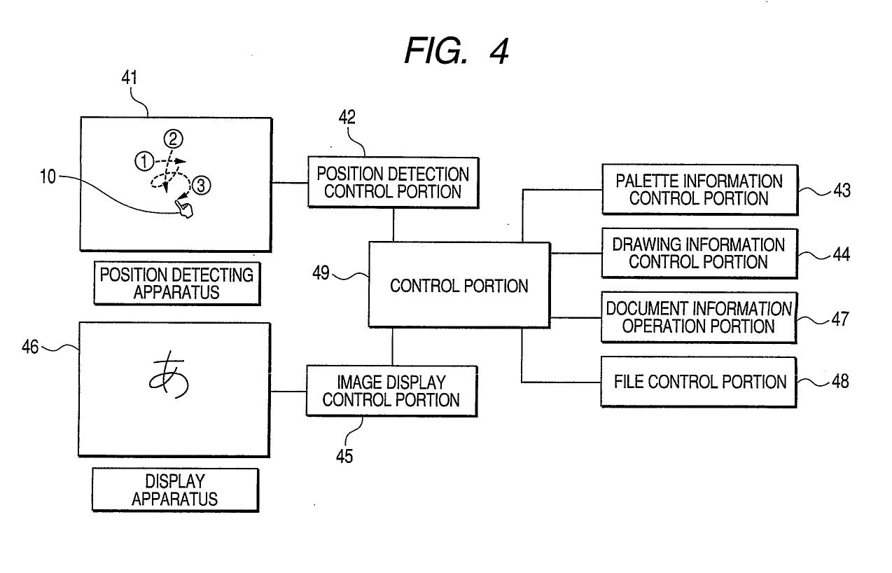

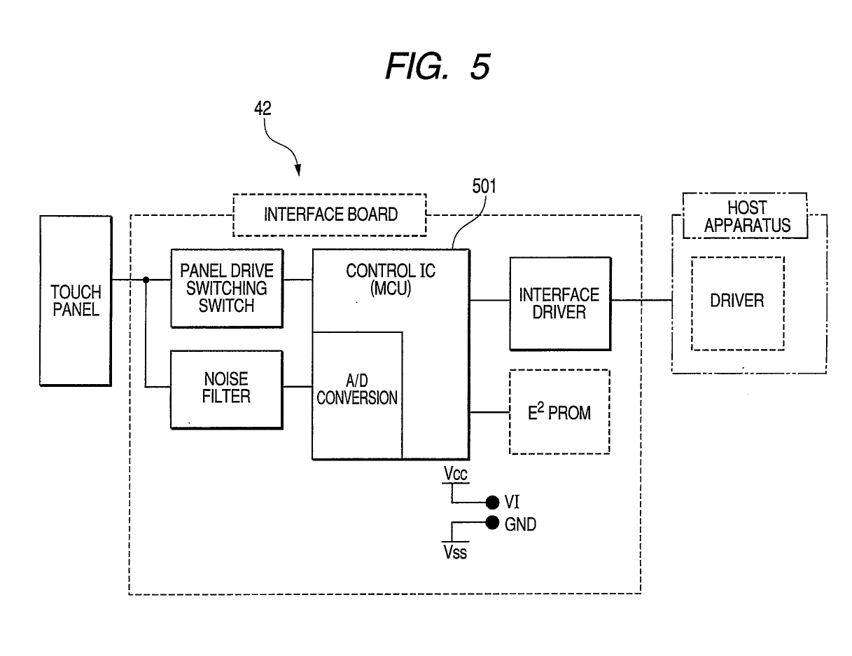

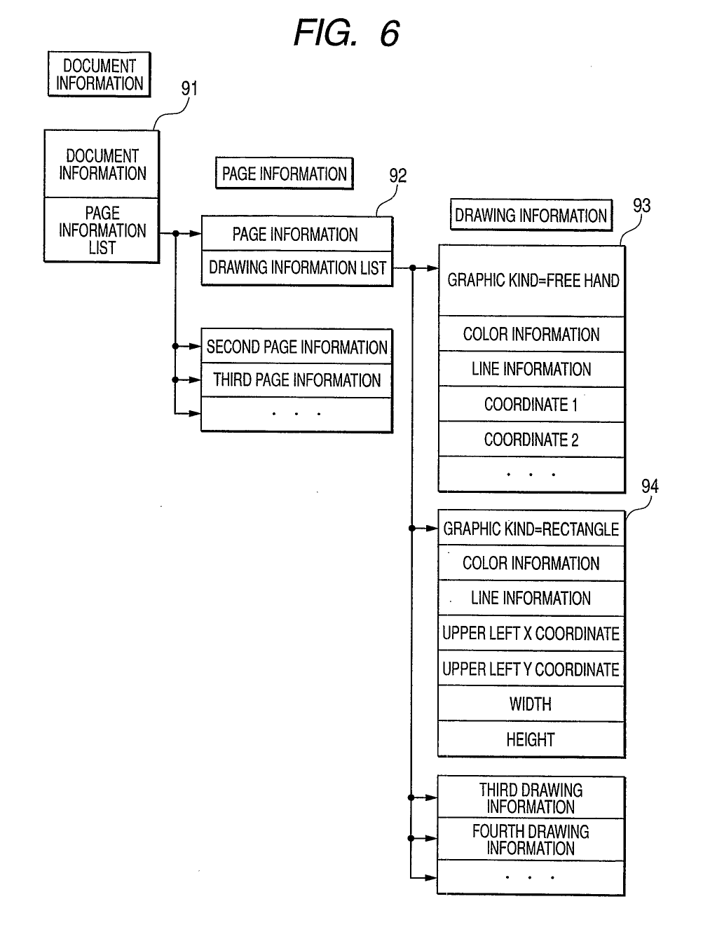

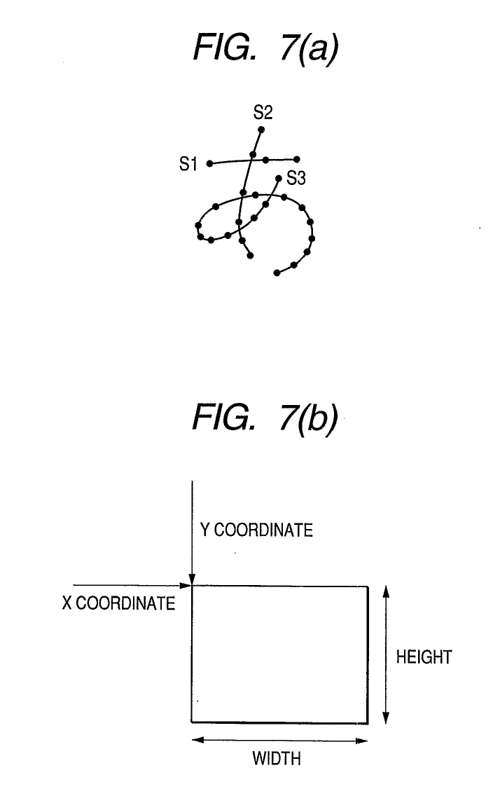

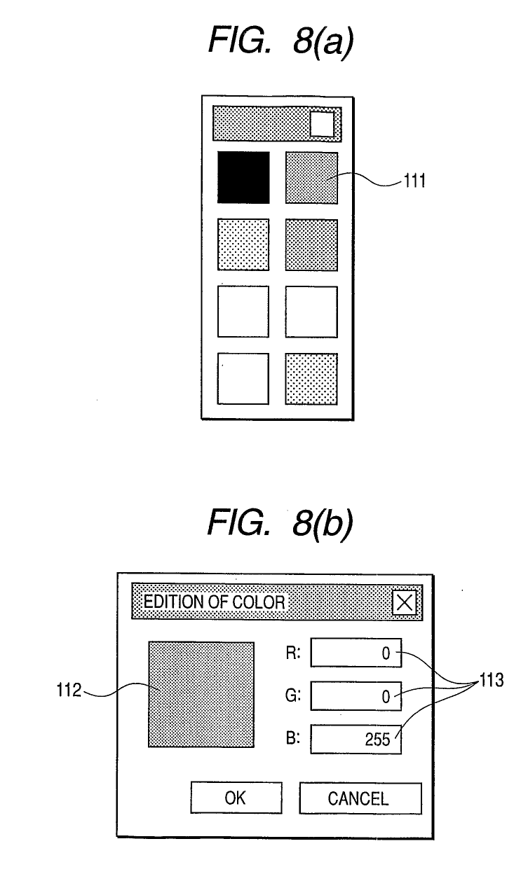

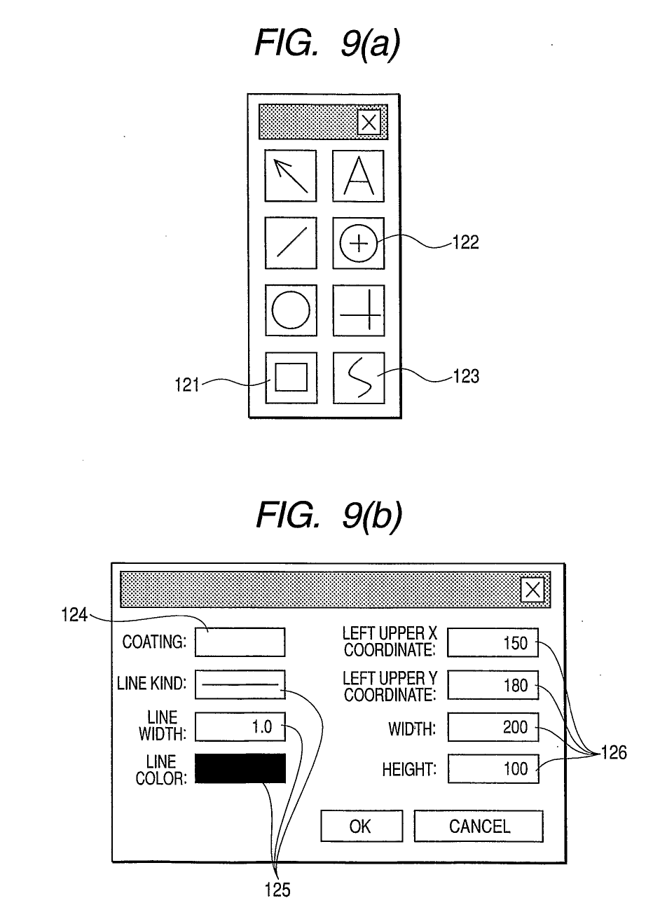

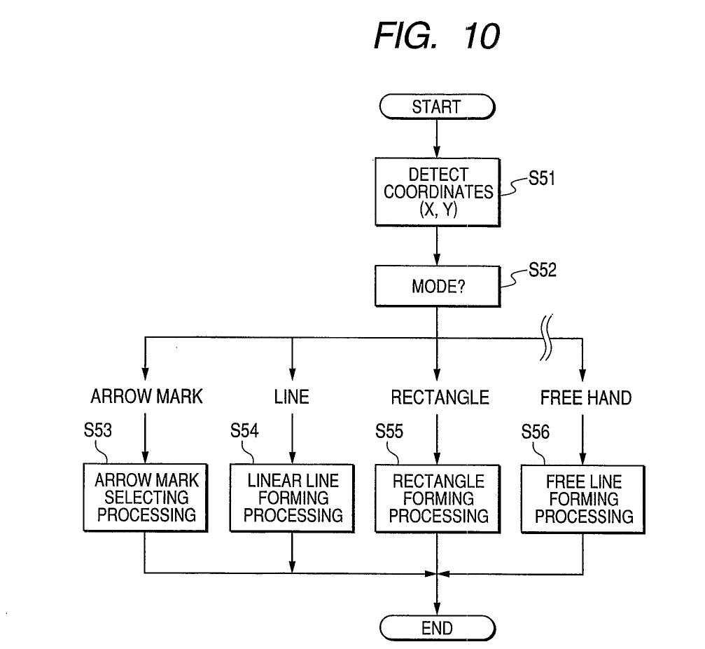

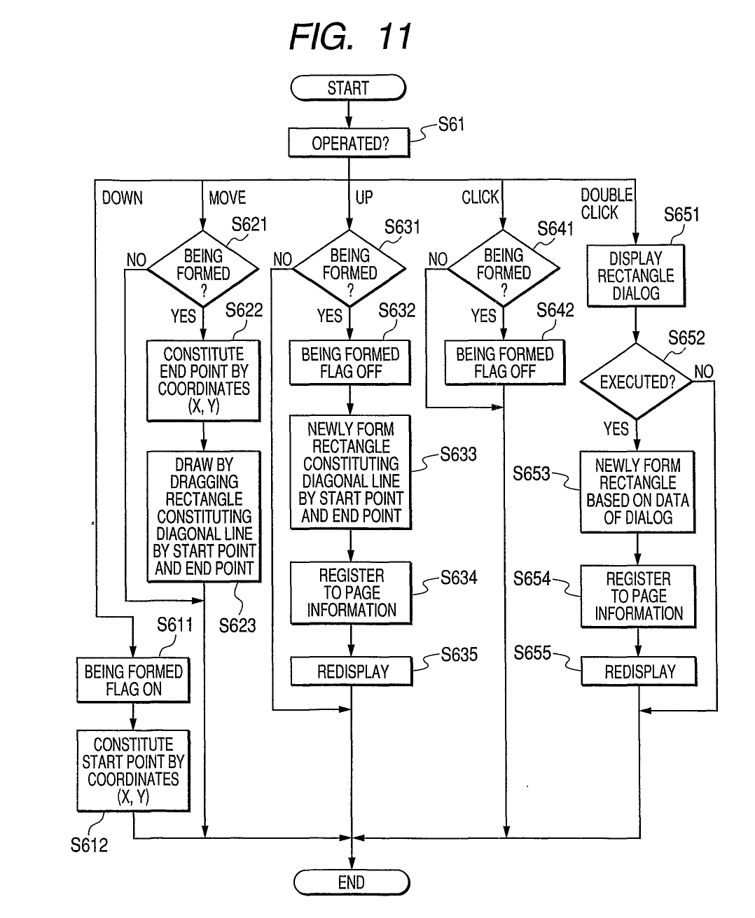

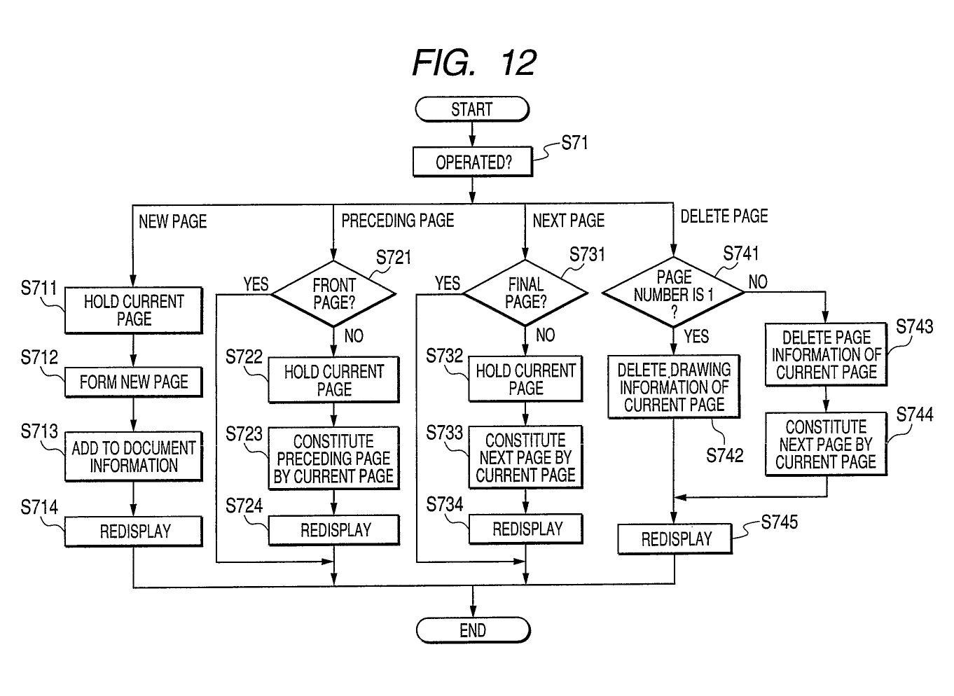

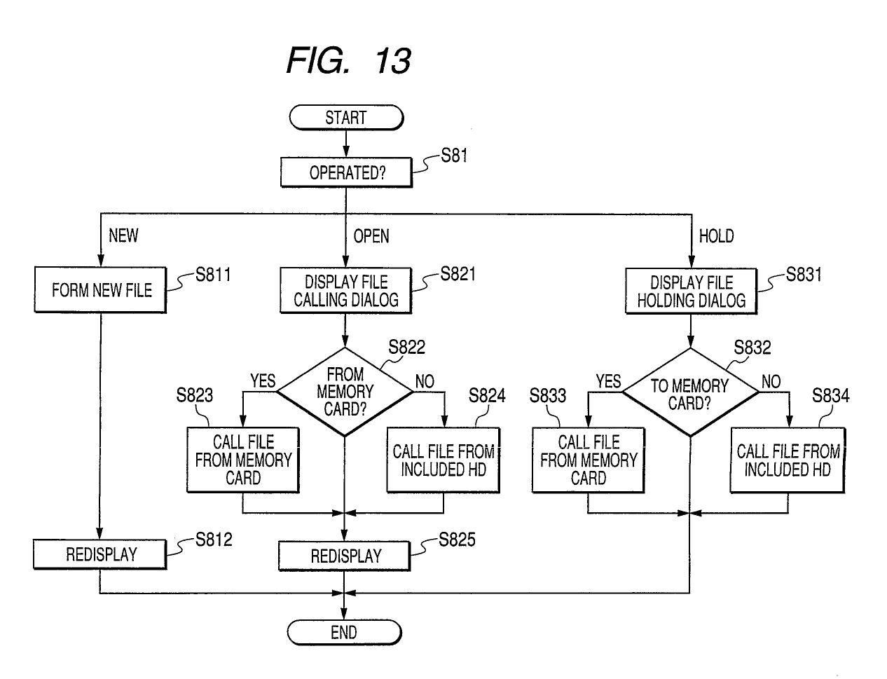

FIG. 1 is an explanatory view showing an electronic blackboard system according to an embodiment of the invention, FIG. 2 is an explanatory view showing a position detecting portion (hereinafter, position detecting apparatus) and a display medium (hereinafter, display apparatus) provided to the electronic blackboard system of FIG. 1, FIG. 3 is a hardware block diagram of a main body provided to the electronic blackboard system of FIG. 1, FIG. 4 is a functional block diagram showing the position detecting apparatus and the display apparatus of FIG. 2, FIG. 5 is a block diagram showing a circuit constitution of the position detecting apparatus of FIG. 2, FIG. 6 is an explanatory view showing a structure of document information in the functional block diagram of FIG. 4, FIG. 7(a) is an explanatory view showing an example of data stored to drawing information of a character, and FIG. 7(b) is an explanatory view showing an example of data stored to drawing information of a rectangle, FIG. 8(a) is an explanatory view enlarging a color palette of the electronic blackboard system of FIG. 1, FIG. 8(b) is an explanatory view showing an example of an edition dialogue screen of a color of the electronic blackboard system of FIG. 1, FIG. 9(a) is an explanatory view enlarging a tool palette 14 of the electronic blackboard system and a position detecting system of FIG. 1, FIG. 9(b) is an explanatory view showing an example of an edition dialog screen for forming or changing a rectangle of the electronic blackboard system and the position detecting system of FIG. 1, FIG. 10 is a flowchart showing processings in operating the position detecting apparatus and the display apparatus of FIG. 2 in operating on a screen, FIG. 11 is a flowchart showing processings in selecting a rectangle in the position detecting apparatus and the display apparatus of FIG. 2 in operating on a screen, FIG. 12 is a flowchart showing processings of the position detecting apparatus and the display apparatus of FIG. 2 in operating a page, FIG. 13 is a flowchart showing processings of the position detecting apparatus and the display apparatus of FIG. 2 in operating a file and FIG. 14 is a block diagram showing the display apparatus provided to the electronic blackboard system of FIG. 1.

First, in FIG. 1, numeral 11 designates a power source switch of an electronic blackboard main body, numeral 12 designates a screen for drawing characters, graphics or the like by a user, numeral 13 designates a color palette for selecting colors attached to loci or graphics by a user, numeral 14 designates a tool palette for selecting what operation is executed on a screen by a user, numeral 15 designates a document operation bar for recording characters, graphics or the like drawn by a user as drawing data of respective pages, calling the characters, the graphics or the like by a unit of page, or holding a plurality of recorded pages as a document in a file style, and numeral 16 designates a slot for inserting an external storing medium of a memory card or the like for holding or calling a file.

In FIG. 1, a detailed description will be given later of the color palette 13 in reference to FIG. 8, of the tool palette 14 in reference to the flowcharts of FIG. 10, FIG. 11, and FIG. 12 and of the document operation bar 15 in reference to the flowcharts of FIG. 12 and FIG. 13.

Further, although in FIG. 1, the color palette 13, the tool palette 14, and the document operation bar 15 are prepared as portions of an application software used on a screen, the color palette 13, the tool palette 14 and the document operation bar 15 may be prepared as mechanisms such as buttons, switches or the like on an external side of the screen.

There may be prepared a palette which can be dealt with as common data such as a line kind palette or the like although in FIG. 1, as palettes, only two kinds of the color palette and the tool palette are prepared.

Next, in FIG. 2, numeral 21 designates an electronic blackboard main body, numeral 22 designates a position detecting apparatus, and numeral 23 designates a display apparatus.

The position detecting apparatus 22 time-sequentially records a position traced by a user on a screen by the member 10 of the finger, a stylus or the like and according to the example, as the position detecting apparatus, a touch screen comprising a transparent material is used. Although the touch screen is made to be transparent since the display apparatus 23 is arranged therebelow, the touch screen may not be transparent when it is devised to enable to detect a position even below the display apparatus 23. Further, although according to the example, the touch screen is used as the position detecting apparatus 22, the position detecting apparatus 22 may be of a system of capable of detecting a position by infrared ray and supersonic wave, or a system of realizing a detecting apparatus at a frame as in an infrared matrix system. However, in this case, the system is more or less inferior to the touch screen in view of a weight thereof.

Here, a structure of the touch screen as the position detecting apparatus will simply be explained.

Generally, as the touch screen, there is a supersonic elastic wave system disclosed in Japanese Patent Application No. 2001-556423, a resistance film type touch panel disclosed in JP-A-2001-283644, or an analog capacitance coupling type disclosed in JP-A-2003-167677 or the like.

Further, there are disclosed a touch panel of a light scanning type in JP-A-2003-177689, further, an infrared ray and supersonic wave type (used in an interactive panaboard of its own company) in JP-A-2003-355188.

Next, a structure showing an example of an electronic paper will be explained.

As a general structure of an electronic paper, there are a twist ball type disclosed in JP-A-2004-45643, an electrophoresis type disclosed in JP-A-2004-45644 and the like.

Here, FIG. 14 is a block diagram of a hardware showing an example of an electronic paper.

A signal with regard to a coordinates position of a member detected by the position detecting apparatus 22 according to an embodiment of the invention is received by a signal receiving and transmitting portion 425 from a signal generating portion 429, and a display light emitting control portion 426 transmits the signal to a display driver 428 by way of a control terminal 427 to display as drawing information by an electronic paper 23.

Further, an electronic blackboard system according to an embodiment of the invention of FIG. 3 is constituted by CPU (central processing unit) 31 for controlling processings, ROM (read only memory) 32 stored with programs executed by CPU 31, RAM (random access memory) 33 temporarily stored with drawing information of characters, graphics or the like drawn by a user, and an auxiliary storing apparatus 34 for holding the drawing information of characters, graphics or the like drawn by a user in a file style and the like.

Next, a constitution of the electronic blackboard system of the invention will be explained.

In FIG. 4, numeral 41 designates a position detecting apparatus for detecting loci drawn by a user on a screen, numeral 42 designates a position detection control portion for controlling the position detecting apparatus, numeral 43 designates a palette information control portion for controlling kinds of a color and a locus drawn on the screen respectively as a color palette and a tool palette, numeral 44 designates a drawing information control portion for controlling the locus detected by the position detecting apparatus 41 as drawing information of a current page, numeral 45 designates an image display control portion for controlling drawing information stored to the drawing information control portion 44 when displayed on the screen, numeral 46 designates a display apparatus for displaying information controlled by the image display control portion 45 on the screen, numeral 47 designates a document information operation portion for storing drawing information of amounts of single pages stored to the drawing information control portion 44 by an amount of a plurality of pages thereof to hold as document information and executing page operation of forming a new page, moving a page, deleting a page or the like, numeral 48 designates a file control portion for holding the document information stored to the document information operation portion 47 at an internal storing apparatus and an external storing apparatus as a file and calling the document information from the storing apparatus, and numeral 49 designates a control portion for controlling a total of the system.

Here, the position detection control portion 42 shown in FIG. 4 is constituted by a block structure as shown by FIG. 5 and a micro control unit 501 in the drawing drives the touch panel constituting the position detecting apparatus.

Next, in FIG. 6, interface document information 91 holds document basic information stored with information commonly used for a total of a document and page information as a list. Page information 92 constituting one unit of the page information list holds page basic information stored with information commonly used for one page, and drawing information as a list. Drawing information 93 and 94 constituting single units of the drawing information list hold a kind of a graphic and graphic data in line with the kind. For example, it is known that the drawing information 93 is defined, as “graphic kind=free hand”, holds positions simply drawn by a user as in, for example, S1 of FIG. 7(a) in an order (time-sequentially) in addition to information with regard to color and information with regard to line and S1, S2, S3 correspond to respective single ones of drawing information and in this case, a character of “a” in Japanese is expressed by gathering three of drawing information of a free hand type. Further, the drawing information 94 is defined as “graphic kind=rectangle” and is stored with information with regard to color and information with regard to line similar to the case of free hand and is thereafter stored with information exclusive for rectangle of (left upper coordinate X, left upper coordinate Y, width, height) as expressed in FIG. 7(b). In this way, a single one of drawing information is constituted by a data structure for holding a kind of a graphic and graphic data in line with the kind.

In FIG. 8(a), numeral 111 expresses one color and in this example, a total of eight kinds of colors are displayed at the color palette. A number of colors to be displayed may freely be set. Further, when an edition dialog screen of color is displayed as shown by FIG. 8(b) though action of double click or the like of 111 in a state of selecting 111, in a state of displaying a current color at 112, in the case of expressing color by, for example, RGB, by changing a numerical value inputted to a numerical value box 113, color can also be edited. Although in this example, in a state of selecting color of the color palette, a selected color is edited, there may be constituted a specification in which by separately displaying an edition dialog screen for displaying all of colors, all of colors can be edited on the screen.

The color palette can be provided to each document information, which is controlled by the palette information control portion 43 in FIG. 4. Information of the controlled color palette is held in document basic information of the document information 91 of FIG. 6. A color selected by the color palette is applied to characters or graphics drawn thereafter. That is, information of color controlled by the palette is held in the drawing information 93 and 94 in FIG. 6.

In FIG. 9(a), numeral 121 designates an icon for forming a rectangle, numeral 122 designates an icon for enlarging or contracting a portion of the screen, and numeral 123 designates an icon for drawing by free hand. Although an explanation of other icon will be omitted, any icon may be prepared so far as the icon is operable on the screen. When a user executes operation of click, double click, drag by the member 10 of the finger, a stylus or the like on the screen, operation thereafter is devised to switch by what is selected by the tool palette. For example, when the rectangle icon 121 is selected, a rectangle constituting a diagonal line by a down position and an up position is formed when the member 10 of the finger or a stylus or the like is operated down→drag→up on the screen. Further, when the enlarge/contract icon 122 is selected, an enlarged or contracted screen centering on the rectangle constituting the diagonal line by the down position and the up position is displayed.

FIG. 9(b) shows an edition dialogue screen for a rectangle displayed through action of double click or the like at an arbitrary position on the screen in a state of selecting the rectangle icon 121 by the tool palette. In FIG. 9(b), numeral 124 designates a color coated on a rectangle, numeral 125 designates a region of setting attributes of a line such as a line kind, a line width, a line color, and numeral 126 designates a region of setting numerical values of the rectangle per se such as upper left X coordinate, upper left Y coordinate, width, height. Information set at the regions is held in the drawing information 94 of FIG. 6.

Information of which icon is selected by the tool palette is controlled by the palette information control portion 43 in FIG. 4. Further, the control portion 49 is devised to acquire information of which icon is selected from the palette information control portion 43 to execute processings thereafter when a user executes operation by the member 10 of the finger, a stylus or the like.

Next, an explanation will be given of flows of main processings according to the embodiment of the invention in reference to respective flowcharts as follows.

First, in FIG. 10, when a user executes some action on the screen by using the member 10 of the finger or a stylus (hereinafter, represented by the finger), the position detecting apparatus 41 in FIG. 4 detects coordinates (X, Y) as a position (step S51). The detected position is informed to the control portion 49 by way of the position detection control portion 42.

At step S52, the control portion 49 in FIG. 4 asks a current mode, that is, which icon is selected at the tool palette to the palette information control portion 43. When the current icon is an arrow mark, the operation proceeds to an arrow mark selecting processing (step S53). When the icon is a linear line, the operation proceeds to a linear line forming processing (step S54). When the icon is a rectangle, the operation proceeds to a rectangle forming processing (step S55). When the icon is free hand, the operation proceeds to a free line forming processing (step S56). Although an explanation of a processing of other icon will be omitted, the operation respectively proceeds to respective processings indicated by icons to finish the processings.

A detailed explanation of the processings at step S53, step S54, step S56 will be omitted and only the rectangle forming processing at step S55 will be explained in details. At step S55, the operation proceeds further to the following rectangle forming processing shown in FIG. 11.

The control operation 49 in FIG. 4 investigates on current operation, that is, what action is executed by a user on the screen (step S61). When there is brought about a state in which a user moves down the finger 10, that is, touches the screen, the operation proceeds to “being formed flag ON” (step S611). When there is brought about a state in which the finger 10 is moved, that is, moved on the screen, it is determined whether the rectangle is being formed (step S621). When the finger 10 is moved up, that is, separated from the screen, it is determined whether the rectangle is being formed (step S631). When the finger 10 executes click, that is, separated from the screen without moving on the screen, it is determined whether the rectangle is being formed (step S641). When the finger 10 executes double click, that is, swiftly repeats click at the same position twice without moving on the screen, rectangle dialog is displayed (step S651).

Next, when the rectangle is being formed, “being formed flag” indicating that the rectangle is being formed is made ON (step S611), the “being formed flag” is stored to the control portion 49 (illustrated in FIG. 4), a start point is constituted by coordinates (X, Y) at the detected position (step S612) to finish the processing and the start point is stored to the control portion 49 (illustrated in FIG. 4).

At step S621, the control portion 49 investigates on whether the “being formed flag” is made ON, that is, whether the rectangle is currently being formed. When the rectangle is being formed, the operation proceeds to step S622. When the rectangle is not being formed, the processing is finished.

At step S622, coordinates (X, Y) of the detected position is made to constitute a new end point, the end point is stored to the control portion 49, and a rectangle constituting the diagonal line by the start point and the end point stored to the control portion 49 is drawn on the screen by using a dotted line or the like as the rectangle being dragged to finish the processing (step S623).

At step S631, the control portion 49 investigates on whether the “being formed flag” is made ON. When the rectangle is being formed, the operation proceeds to step S632. When the rectangle is not being formed, the processing is finished.

At step S632, the control portion 49 makes the “being formed flag” OFF in order to show that the rectangle is finished to be formed.

At step S633, the control portion 49 newly forms the rectangle constituting the diagonal line by the start point and the end point as new drawing information. In FIG. 6, the drawing information 94 corresponds thereto. At this occasion, color information is acquired from a currently selected color held by the palette information control portion 43. When other palette dealing with common data of a line kind palette or the like is present, information is acquired therefrom.

At step S634, the control portion 49 delivers the formed drawing information 94 to the drawing information control portion 44 (illustrated in FIG. 4) and the drawing information control portion 44 registers the drawing information 94 of FIG. 5 to the drawing information list of current page information controlled by the drawing information control portion 44 per se.

At step S635, the control portion 49 requests the image display control portion 45 in FIG. 4 to display the previously formed drawing information 94 of a current page controlled by the drawing information control portion 44 and the image display control portion 45 displays the rectangle at the display apparatus 46 to finish the processing.

At step S641, the control portion 49 investigates on whether the “being formed flag” is made ON. When the rectangle is being formed, the operation proceeds to step S642. When the rectangle is not being formed, the processing is finished.

At step S642, the control portion 49 makes the “being formed flag” OFF to finish the processing in order to indicate that the rectangle has been finished to form. In this case, the finger 10 is not moved from the start point and therefore, the rectangle is not formed.

At step S651, the control portion 49 displays a dialog screen for editing the rectangle of FIG. 9(b). The user inputs a desired numerical value on the dialog screen and selects execution or cancel.

At step S652, the control portion 49 investigates on whether the dialog screen is executed. When executed, the operation proceeds to step S653. When canceled, the processing is finished.

At step S653, the rectangle is newly formed as the new drawing information based on data inputted to the dialog screen. The drawing information 94 in FIG. 6 corresponds thereto.

At step S654, the control portion 49 delivers the formed drawing information 94 to the drawing information control portion 44, and the drawing information control portion 44 registers the drawing information 94 to the drawing information list of current page information controlled by the drawing information control portion 44 per se.

At step S655, the control portion 49 requests the image display control portion 45 in FIG. 4 to display the previously formed drawing information 94 of the current page controlled by the drawing information control portion 44 and the image display control portion 45 displays the rectangle at the display portion 46 to finish the processing.

An explanation will be given of a procedure of processings when a user selects any of buttons with regard to page operation of the document operation bar 15 in FIG. 1 by the member 10 of the finger, a stylus or the like in reference to FIG. 11.

First, the user selects a page operation button of any of “new page”, “preceding page”, “next page”, “page deletion” by using the member 10 of the finger, a stylus or the like (step S71). At step S71, the control portion 49 investigates on which page operation button is selected by the user. When the “new page” button is selected, the control portion 49 requests a new page forming processing to the document information operating portion 47 (step S711), when the “preceding page” button is selected, the control portion 49 requests the preceding page moving processing (step S721), when the “next page” button is selected, the control portion requests a next page moving processing (step S731) and when the “page deletion” button is selected, the control portion requests a page deleting processing (step S741).

When a new page is formed, at step S711, the document information operation portion 47 overwrites information of a current page stored to the drawing information control portion 44 on corresponding page information of the document information operation portion 47 to hold (step S711), and the document information operation portion 47 newly forms the page information 92 of FIG. 6 (step S712).

At step S713, the document information operation portion 47 registers the formed page information 92 to the page information list of the document information 91 and delivers the page information 92 to the drawing information control portion 44 as the current page.

At step S714, the control portion 49 requests the image display control portion 45 in FIG. 4 to display the current page controlled by the drawing information control portion 44 and the image display control portion 45 displays the current page at the display apparatus 46 to finish the processing.

At step S721, the document information operation portion 47 investigates on whether the current page is a front page. When the current page is the front page, the page cannot further be moved frontward and therefore, the processing is finished as it is. Otherwise, the operation proceeds to step S722.

At step S722, the document information operation portion 47 overwrites information of the current page stored to the drawing information control portion 44 on corresponding page information of the document information operation portion 47 to hold.

At step S723, the document information operation portion 47 delivers page information of one page before to the drawing information control portion 44 as the current page.

At step S724, the control portion 49 requests the image display control portion 45 in FIG. 4 to display the current page controlled by the drawing information control portion 44 and the image display control portion 45 displays the current page at the display apparatus 46 to finish the processing.

At step S731, the document information operation portion 47 investigates on whether the current page is a final page. When the current is the final page, the page cannot further be moved rearward and therefore, the processing is finished as it is. Otherwise, the operation proceeds to step S732.

At step S732, the document information operation portion 47 overwrites information of the current page stored to the drawing information control portion 44 on corresponding page information of the document information operation portion 47 to hold.

At step S733, the document information operation portion 47 delivers page information one page after to the drawing information control portion 44 as the current page.

At step S734, the control portion 49 requests the image display control portion in FIG. 4 to display the current page controlled by the drawing information control portion 44 and the image display control portion 45 displays the current page at the display apparatus 46 to finish the processing.

At step S741, the document information operation portion 47 investigates on whether a current page number is 1. When the current page number is 1, the operation proceeds to step S742. Otherwise, the operation proceeds to step S743.

At step S742, the document information operation portion 47 deletes only all of drawing information registered at the drawing information list of the image information 92 in FIG. 6 of the current page since the page cannot be deleted further. Further, the page information is delivered to the drawing information control portion 44 as the current page.

At step S743, the document information operation portion 47 deletes page information of the current page. That is, only page information constituting the current page is deleted from the page information list of the document information 91 in FIG. 6.

At step S744, the document information operation portion 47 delivers page information one page after of page information deleted as the current page to the drawing information control portion 44.

At step S745, the control portion 49 requests the image display control portion 45 in FIG. 4 to display the current page controlled by the drawing information control portion 44 and the image display control portion 45 displays the current page at the display apparatus 46 to finish the processing.

FIG. 13 explains processings when a user selects any button with regard to file operation of the document operation bar 15 in FIG. 1 by the member 10 of the finger, a stylus or the like.

First, a user selects a file operation button of any of “new”, “open”, “hold” on the screen by using the member 10 of the finger, a stylus or the like (step S81).

At step S81, the control portion 49 in FIG. 4 investigates on which file operation button is selected by the user. When the “new” button is selected, the control portion requests a new file forming processing to the file control portion 48 (step S811). When the “open” button is selected, the control portion requests a file calling processing to the file control portion 48 (step S821). When the “hold” button is selected, the control portion requests a file holding processing to the file control portion 48 (step S831).

At step S811, the file control portion 48 newly forms a file and delivers information of the formed file, that is, document information to the document information operation portion 47. The document information operation portion 47 reads document information from the new file and delivers a first page of page information as the current page to the drawing information control portion 47.

At step S812, the control portion 49 requests the image display control portion 45 in FIG. 4 to display the current page controlled by the drawing information control portion 44 and the image display control portion 45 displays the current page at the display apparatus 46 to finish the processing.

At step S821, the file control portion 48 displays a file call dialog screen for calling a desired file. A user designates a file stored to an external storing apparatus of an included hard disk, a memory card or the like.

At step S822, the file control portion 49 investigates on whether the designated file is a file stored to the external storing apparatus of a memory card or the like. In the case of the file stored to the external storing apparatus of the memory card or the like, the operation proceeds to step S823. Otherwise, in the case of the file stored to the external storing apparatus of the included hard disk or the like, the operation proceeds to step S824.

At step S823, the file control portion 48 makes access to the external storing apparatus of the memory card or the like and delivers the designated file as document information to the document information operation portion 47. The document information operation portion reads document information from the designated file and delivers a first page of page information as the current page to the drawing information control portion 44.

At step S824, the file control portion 48 makes access to the external storing apparatus of the included hard disk or the like and delivers the designated file as document information to the document information operation portion 47. The document information operation portion 47 reads document information from the designated file and delivers a first page of page information as the current page to the drawing information control portion 44.

At step S825, the control portion 49 requests the image display control portion 45 in FIG. 4 to display the current page controlled by the drawing information control portion 44 and the image display control portion 45 displays the current page at the display apparatus 46 to finish the processing.

At step S831, the file control portion 48 displays a file holding dialog screen for holding currently displayed document information as a file. A user designates the external storing apparatus of an included hard disk, a memory card or the like as a destination of holding a file.

At step S832, the file control portion 48 investigates on whether the file is held at the external storing apparatus of a memory card or the like. In the case of holding the file to the external storing apparatus of the memory card or the like, the operation proceeds to step S833. Otherwise, in the case of holding the file at the external storing apparatus of the included hard disk or the like, the operation proceeds to step S834.

At step S833, the file control portion 48 receives current document information from the document information operation portion 47, makes access to the external storing apparatus of the memory card or the like and holds the current document information as a file to finish the processing.

At step S834, the file control portion 48 receives current document information from the document information operation portion 47, makes access to the external storing apparatus of the included hard disk or the like and holds the current document information as the file to finish the processing.

As described above, according to the display system of the embodiment of the invention, the apparatus per se is mounted with the position detecting means and the display means which are light-weighted and therefore, the user can draw characters or graphics on the screen without an exclusive pen of a marker or an electronic pen and without connecting a projector or PC, and can easily move the apparatus.

Further, when characters or graphics are drawn on the screen, color, a kind of graphic or the like is made to be able to be selected and therefore, a user can set color to a character to be drawn on or draw a graphic.

Further, loci drawn on the screen can be recorded for respective pages, and pages having loci can be called by operating pages, pages can be held and called as a file style and therefore, a user can call a new page without erasing previous loci, call at once a previously drawn page, and hold and call all of the drawn content as a file having a plurality of pages.

As described above, according to the electronic blackboard system of the embodiment of the invention, the light-weighted electronic blackboard can be realized by combining the touch screen and the electronic paper, and a user can display characters or graphics traced by the member 10 of the finger or a stylus on the screen as they are on the screen without a marker or an electronic pen and can easily carry the apparatus. Further, since the electronic blackboard per se is mounted with the position detecting means and the displaying means which are light-weighted and therefore, a user can draw sentences or graphics on the screen without connecting a projector or PC and can easily move the apparatus.

Further, the display apparatus 23 reproduces a position detected by the position detecting apparatus 22 and according to the example of the invention, an electronic paper is used therefor. Although in this example, the display apparatus 23 is constituted by the electronic paper, the display apparatus 23 may be other display of an organic EL or the like so far as the display is thin and light-weighted.

Further, as a memory or a recording apparatus used in the embodiment, a disk apparatus of an ultra small type HDD explained below can also be used. According to the disk apparatus, a transverse width of a bottom face thereof is about 20 mm through 30 mm, a length thereof is about 25 mm through 40 mm and a thickness thereof is about 2.5 mm through 4.8 mm. The disk apparatus is provided with a storing capacity equal to or larger than GByte. Further, a weight thereof is equal to or lighter than about 10 g.

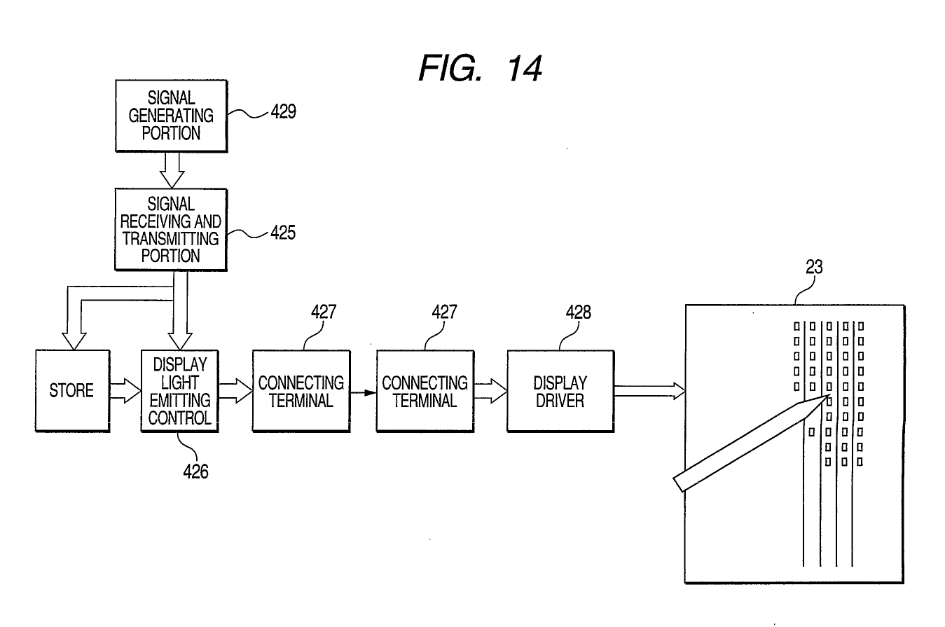

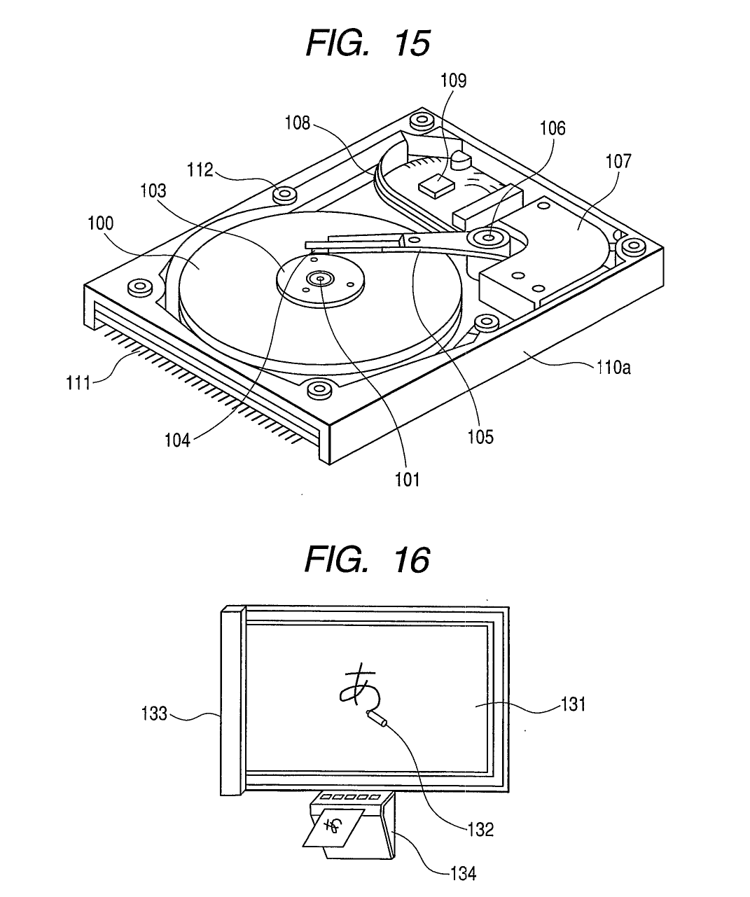

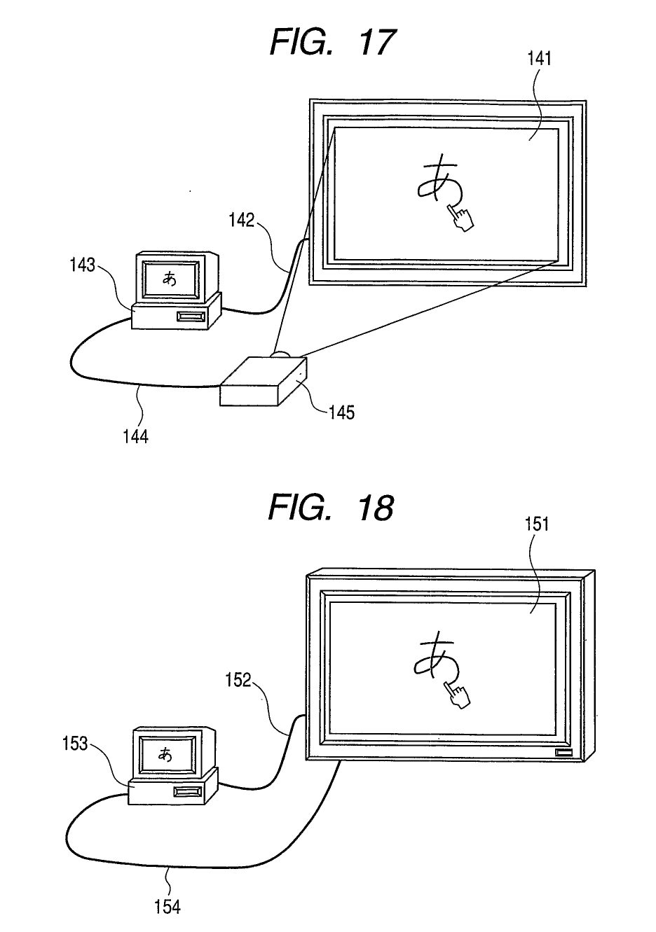

FIG. 15 is a perspective view of an essential portion of the disk apparatus. Further, FIG. 18 is shown in a state of removing a ceiling plate (not illustrated) of a cabinet to be able to see inside of the disk apparatus. Actually, the disk apparatus is mounted and used in a state of hermetically closing to seal inside of the apparatus by the ceiling plate (not illustrated). A disk 100 is driven to rotate by driving means (not illustrated) by being supported by a main shaft 101. As the driving means (not illustrated), for example, a spindle motor is used. A head slider 104 having a head element (not illustrated) for executing recording and reproduction is fixed to a support arm 105, further, the support arm 105 is rotatably attached to a bearing portion 106.

For example, a voice coil motor is used for pivoting means 107 for moving the head element (not illustrated) to a predetermined track position of the disk 100 by pivoting the support arm 105. A flexible wiring board 108 is drawn from a side face of the bearing portion 106 for transmitting a signal to the head element (not illustrated) and conduct electricity to the pivoting means 107, and connected to a control circuit board (not illustrated) attached to a lower side of a base 110a via a signal amplifier 109 provided in the base 110a. Further, one end portion of the control circuit board (not illustrated) is provided with a connector 111 for connecting the disk apparatus and other apparatus to expose from an end portion of the base 110a.

The base 110a is provided with a screw fastening portion 112 and a housing 110 integrated by fastening the ceiling plate, not illustrated, by a screw is constituted. Further, in connecting the disk apparatus and other apparatus, there is also a case of drawing out the flexible wiring board without using the connector 111.

This application is based upon and claims the benefit of priority of Japanese Patent Application No. 2004-155834 filed on May 26, 2004, the contents of which are incorporated herein by reference.

According to the disk apparatus constituted as described above, when the disk 100 is rotated by driving means (not illustrated), an air flow is produced at a surface of the disk 100 and the head slider 104 held on the disk 100 is floated up. In such a floated-up state, by the head element (not illustrated), recording of information to the disk 100, or reproduction of information recorded to the disk 100 is executed.

1. An electronic blackboard system characterized in an electronic blackboard comprising:
a position detecting portion, detecting a coordinates position with which a writing member is brought into contact;
a display medium, in which a pixel selectively produces a color by electricity conduction and a color-produced state is maintained even after cutting the electricity conduction;
a control portion, controlling to execute drawing directly on the display medium based on position information from the position detecting portion; and
a storing portion, storing drawing information drawn on the display medium.

2. The electronic blackboard according to claim 1, wherein the position detecting portion is a touch screen.

3. The electronic blackboard system according to claim 1, wherein the display medium is an electronic paper.

4. The electronic blackboard system according to claim 1, wherein the member is the finger or a stylus.

5. The electronic blackboard system according to claim 1, wherein the position detecting portion is arranged at a front face of the display medium.

6. The electronic blackboard system according to claim 1, wherein the position detecting portion is arranged at a rear face of the display medium.

7. An electronic blackboard system characterized in an electronic blackboard system capable of recording a character or the like drawn on a screen, said electronic blackboard system comprising:
a position detector, detecting a locus drawn on the screen;
a position detection controller, controlling a detecting processing of the position detector;
a drawing information controller, controlling the locus detected by the position detector as drawing information;
a screen display controller, executing a control when the drawing information stored to the drawing information controlling means is displayed on the screen;
a display, displaying the drawing information controlled by the screen display controller on the screen; and a controller, controlling a total of the system;
wherein the controller comprises a palette information controller for controlling a data usable commonly in the system of a color drawn on the screen, or a kind of the locus respectively as a palette;
a document information operator, storing a plurality of pages of the drawing information stored to the drawing information controller as document information for executing a page operation of forming a new page, moving a page, deleting a page or the like; and
a file controller, holding the document information stored to the document information operator as a file at an internal storing apparatus and an external storing apparatus and calling the document information from the storing apparatus;
wherein the locus drawn on the screen can be recorded at each page, and can be displayed by the displaying means by calling the page having the locus by executing the page operation and can be held or called also as a file style.

8. The electronic blackboard system according to claim 7, wherein the document information operating portion holds document basic information used commonly in a total of a document.

9. The electronic blackboard system according to claim 7, wherein the document information operating portion holds page information as a list.

10. The electronic blackboard system according to claim 7, wherein the page information holds page basic information stored with information commonly used in a corresponding page.

11. The electronic blackboard system according to claim 7, wherein the page information holds the drawing information stored with the drawing information commonly used in the corresponding page.

12. The electronic blackboard system according to claim 7, wherein the drawing information is a kind of a graphic and a graphic data.

13. The electronic blackboard system according to claim 7, wherein the drawing information is information with regard to a color or a line.

14. The electronic blackboard system according to claim 7, wherein the drawing information time-sequentially holds coordinates with regard to the locus detected by the position detecting portion.

15. A method of controlling display of an electronic blackboard characterized in an electronic blackboard, said method comprising the steps of:
detecting a position of a member with which a touch screen is brought into contact on a screen;
controlling the position of the member as drawing information by a drawing information control portion;
displaying the drawing information by an electronic paper;
operating the drawing information as document information by the document information operating portion; and
holding the document information as a file by a file control portion.
